(19) United States
(12) Patent Application Publication
(10) Pub. No.: US 2013/0223443 A1
(43) Pub. Date: Aug. 29, 2013

(54) DISTRIBUTION TREES WITH STAGES

(71) Applicant: Michael L. Ziegler, Roseville, CA (US)

(72) Inventor: Michael L. Ziegler, Roseville, CA (US)

(21) Appl. No.: 13/407,125

(22) Filed: Feb. 28, 2012

(51) Int. Cl. H04L 12/56

(52) U.S. Cl. 370/390

(57) ABSTRACT

Techniques described herein provide for sending packets to nodes based on distribution trees with stages. A packet may be received at a node. The stage of the node may be determined. A distribution tree may be selected. Based on the stage and the selected distribution tree, subsequent stage nodes may be determined. The packet may be sent to the subsequent stage nodes.

### BACKGROUND

Data networks are used to allow many types of electronic devices to communicate with each other. Typical devices can include computers, servers, mobile devices, game consoles, home entertainment equipment, and many other types of devices. These types of devices generally communicate by encapsulating data that is to be transmitted from one device to another into data packets. The data packets are then sent from a sending device to a receiving device. In all but the simplest of data networks, devices are generally not directly connected to one another.

Instead, networking devices, such as switches and routers, may directly connect to devices, as well as to other networking devices. A network device may receive a data packet from a device at an interface that may be referred to as a port. The network device may then forward the data packet to another port for output to either the desired destination or to another network device for further forwarding toward the destination. The bandwidth available in a network device for such data transfer may be finite, and as such it would be desirable to make such transfers as efficient as possible.

### BRIEF DESCRIPTION OF THE DRAWINGS

FIG. 1 is an example of a networking device and stage zero of a distribution tree.

FIG. 2 is an example of stage one of a distribution tree.

FIG. 3 is an example of stage two of a distribution tree.

FIG. 4 is an example of packet indication messages.

FIG. 5 is an example of a stage zero distribution table.

FIG. 6 is an example of a stage one distribution table.

FIG. 7 is an example of a stage two distribution table.

FIG. 8 is an example of pruning a distribution tree.

FIG. 9 is an example of a high level flow diagram for distributing a packet.

FIG. 10 is another example of a high level flow diagram for distributing a data packet.

FIG. 11 is an example of a high level flow diagram for distributing a packet with distribution tree pruning.

FIG. 12 is another example of a high level flow diagram for distributing a packet with distribution tree pruning.

FIG. 13 depicts an example of populating the distribution tables.

### DETAILED DESCRIPTION

In one mode of operation of a networking device, such as a switch or router, a packet may be received at one port of the device, which will be referred to as the input port. Several ports may be aggregated to form a node, which may be referred to as the input node or originating node. The packet may be destined to be output on a different port on a different node of the networking device, which will be referred to as the output port on the output node. The packet may be received at the input port and the correct output port is determined. The packet may then be inserted into a switch fabric, also referred to as simply a fabric, for routing to the output port. Packets may arrive at the input port at a certain rate or bandwidth. For example, packets may arrive at a rate of 10 Gigabits(Gb)/second(sec). As such, packets would only be inserted into the switch fabric at generally the same rate. In other words, if packets are received at an input port with a bandwidth of 10 Gb/sec the input node would insert packets onto the fabric at approximately the same rate. Thus, the fabric interface bandwidth needed is approximately equal to the rate of arrival of packets.

However, there is another mode of operation of a networking device in which packets may still be received by a single input port but are destined for more than one output ports within the networking device. One such example of operation in the second mode is broadcast packets. A broadcast packet may be received at an input port and is destined to be output on all other ports within the networking device. Another example of operation in the second mode is multicast packets. A multicast packet is similar to a broadcast packet, except that instead of being destined for all output ports, the multicast packet is destined for some subset of all ports, wherein the subset may include all ports. Furthermore, there may be multiple multicast sessions. An individual multicast session may be a stream of packets that are destined for the same set of output ports. Each multicast session may have a different set of desired output ports. In the second mode of operation the packet is thus received at one node and is to be sent to some or all of the other nodes in the device.

Operation in the second mode may result in a problem with respect to the amount of bandwidth into the fabric that is required. As mentioned above, in the case where packets are destined for only a single port, the fabric interface bandwidth used is approximately equal to the rate of arrival of packets. However, in the case of broadcast or multicast packets, the amount of bandwidth into the fabric becomes a multiple of the number of nodes to which the packet must be delivered. For example, if packets arrive at a rate of 10 Gb/sec, but each packet is destined for ten nodes, the fabric interface bandwidth required is increased by tenfold. As the rate of incoming packets increases and the number of nodes within a networking device increases, the fabric interface bandwidth needed becomes unsustainable.

Example embodiments described herein overcome this problem by providing techniques that segment the distribution of a packet into multiple stages. A packet may be received by an originating node, which may also be referred to as a stage zero node. The stage zero node may select a subset of nodes, referred to as stage one nodes, and send an indication that a packet is available to the selected stage one nodes. The stage one nodes in turn select a subset of nodes, referred to as stage two nodes, and send the indication of the availability of the packet to the stage two nodes. The stage two nodes in turn select a subset of nodes, referred to as stage three nodes, and send the indication of the availability of the packet to the stage three nodes. As such, no individual node is responsible for sending the packet to the complete set of nodes, thus reducing the fabric interface bandwidth used by any individual node when sending broadcast or multicast packets.

Furthermore, the particular selection of stage one, two, and three nodes creates a node pattern that an individual packet will traverse. Based on the particular nodes chosen, which can also be referred to as a distribution tree, a packet may be distributed to the nodes. Multiple distribution trees may be defined, such that all packets arriving at a given originating node that are destined for multiple nodes do not necessarily follow the same distribution tree. As such, even in cases where there are many packets arriving at a given originating node that are destined for all other nodes, it is possible to spread those packets across different distribution trees, such that no single distribution tree, and hence fabric interface for a node within that distribution tree, becomes overloaded with packets.

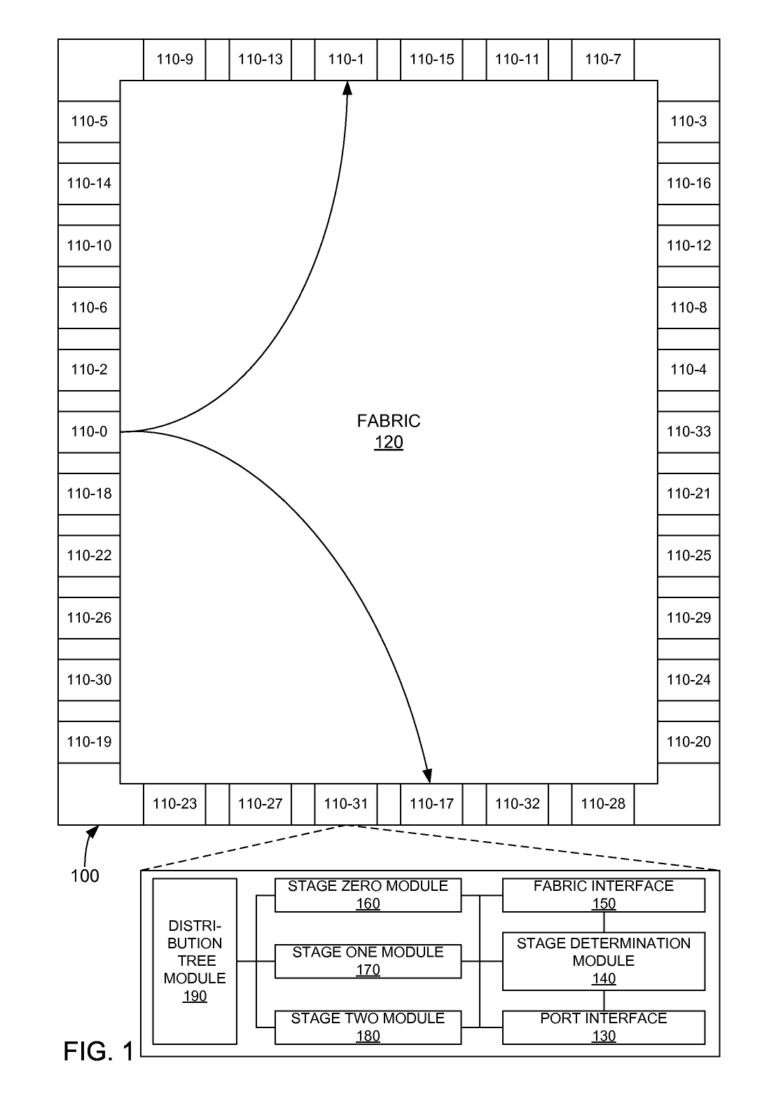

FIG. 1 is an example of a networking device and stage zero of a distribution tree. The networking device 100 may include a plurality of nodes 110-(0-33). A more detailed description of the nodes is provided below. Each of the nodes may be connected to a fabric 120. The fabric 120 provides a communications path that allows any of the nodes to send messages to and receive messages from the other nodes. The nodes as shown in FIG. 1 are dispersed about the networking device in what appears to be a random manner. However, it should be understood that nothing is intended to be implied by the ordering of the nodes. The nodes are ordered as shown for purposes of ease of depiction of a distribution tree. The techniques described herein are independent of any particular layout of nodes within the networking device.

The structure of each of nodes 110-x is generally identical. An example of the structure of a node 110-31 is shown in FIG. 1 and it should be understood that all the other nodes may have generally the same structure. Node 110-31 may include a plurality of ports (not shown). The ports may be used to connect to external sources of packets, such as computers, servers, or even other network devices. The number of ports that exist on a node may be determined by the design of the network device. For example, in some modular switches, capacity may be added by inserting an additional line card containing 4, 8, 16, or 32 ports. The line card may also contain a node chip to control the data packets sent to and received from the ports. In some cases, depending on the number of ports included on a line card, more than one node chip may be required. However, for purposes of this explanation, a set of ports may be controlled by a single node chip.

The node chip, which may simply be referred to as a node, may typically be implemented in hardware. Due to the processing speed requirements needed in today's networking environment, the node may generally be implemented as an application specific integrated circuit (ASIC). The ASIC may contain memory, general purpose processors, and dedicated control logic. The various modules that are described below may be implemented using any combination of the memory, processors, and logic as needed.

The node 110-31 may include a port interface 130, a stage determination module 140, a fabric interface 150, stage zero module 160, stage one module 170, stage two module 180, and distribution tree module 190. The port interface 130 may be responsible for receiving packets from the external ports and sending those packets to other nodes via the fabric 120. Likewise, the port interface may also be responsible for receiving packets from other nodes, and outputting those packets via the ports. Just as the port interface is responsible for communicating packets to/from the external ports, the fabric interface 150 may be responsible for communicating packets from the node to and from the fabric. The techniques described herein are helpful in reducing the bandwidth used by the fabric interface. When a message is to be sent to another node, the node may use the fabric interface to communicate the message to the fabric for delivery to the node that is the destination for the message.

The stage determination module 140 may receive an indication of a data packet from the port interface 130 or the fabric interface 150 and determine if the packet is destined for other nodes. The stage determination module may determine if the node is acting as the stage zero node, which means that it is the node that has received the packet from the external port. The stage determination module may also determine if the node is acting as the stage one or two node, which means that the node has received the indication of the packet from another node, but the packet may need to be further forwarded.

Based on the determination of which stage a particular node is, the stage determination module may send the indication of the availability of the data packet to the stage zero 160, stage one 170, or stage two 180 module. In the case of a node acting as a stage zero node, the stage zero module may select a distribution tree from the distribution tree module 190. The stage zero module may then send the indication of the availability of the data packet to the nodes determined from the selected distribution tree. Included in the indication may be a stage identifier that identifies the indication as coming from a stage zero node. Also included may be a distribution tree identifier that may identify the selected distribution tree. Likewise, the stage one and two modules may retrieve the appropriate portion of the selected distribution tree and send an indication of the availability of the packet to the nodes indicated by the distribution tree. Again, included may be an indicator that identifies that the indication of the availability of a packet is coming from a stage one or stage two node respectively. The selected distribution tree may also be included. The operation of the nodes when receiving an incoming packet is described in further detail below.

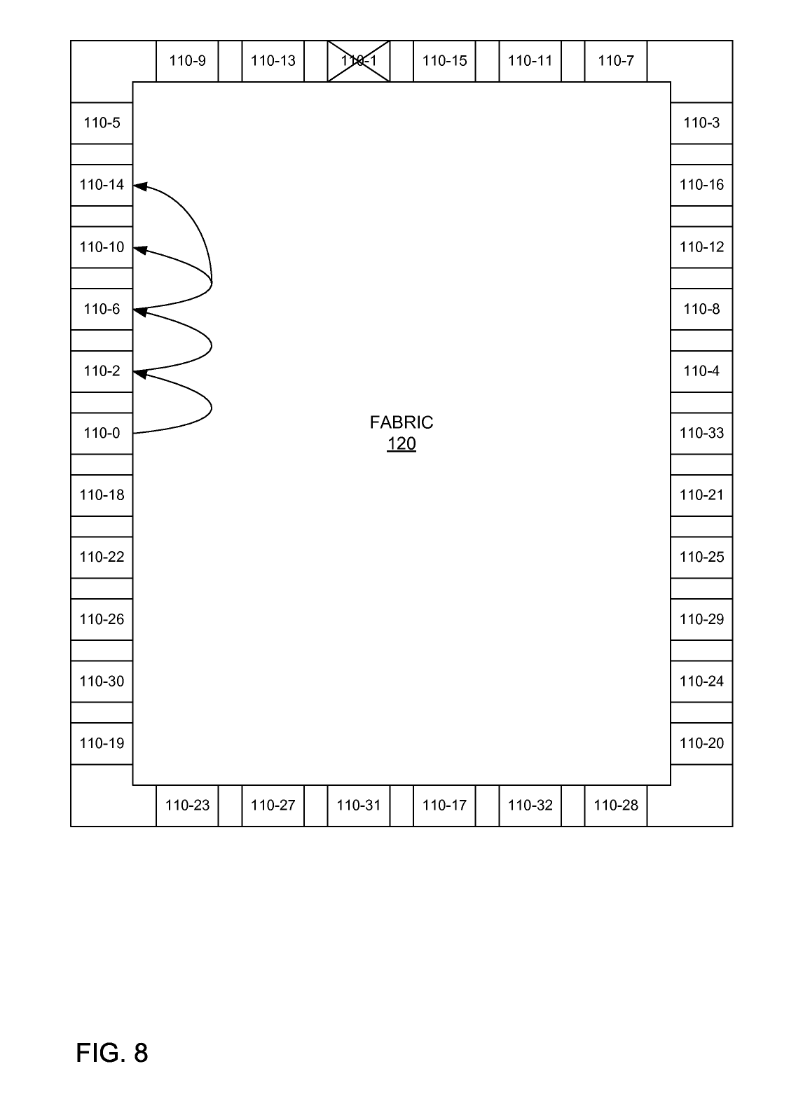

In operation, a packet may be received at an external port. For example, a packet may be received by one of the ports of node 110-0 through its port interface. The stage determination module may determine that the packet is destined for multiple active nodes within the networking device. For purposes of this description, an active node is a node that is operational and needs the packet. In some cases a node may be out of service, and thus is not considered active. In other cases, it may be determined that a node does not need the packet. For example, in the case of a multicast packet, a given node may have no ports that are part of the multicast session (e.g. the packet need not be output on any port associated with the node). Thus, even though the node is active, it does not need the packet. A node that does not need a packet may be treated just as if it were not active. For ease of description, the following example is presented in terms of a packet that is needed by all nodes and that all nodes are in service. A description of the case when a node is not active or does not need the packet is presented with respect to FIG. 8. The stage determination module may also determine that the packet was received from an external port, and as such node 110-0 is the stage zero, also referred to as the originating, node. The stage zero module may then select a distribution tree from amongst a plurality of distribution trees from the distribution tree module. The distribution trees will be explained in further detail below, but for now, the stage zero module selects a distribution tree, which in turn specifies the nodes to which the indication of the availability of the data packet is to be sent. The selection of a distribution tree may occur in a number of different ways. For example, the selection may be random. Or, the selection may be based on the incoming packet. In the case of multicast packets, it may be desirable to have all packets from an individual multicast session follow the same distribution tree to ensure a more deterministic behavior of packets as they flow to the output ports. Thus, the tree may be selected based on the tree currently in use for the multicast session. The nodes that receive an indication of the availability of a data packet from a stage zero node are referred to as stage one nodes.

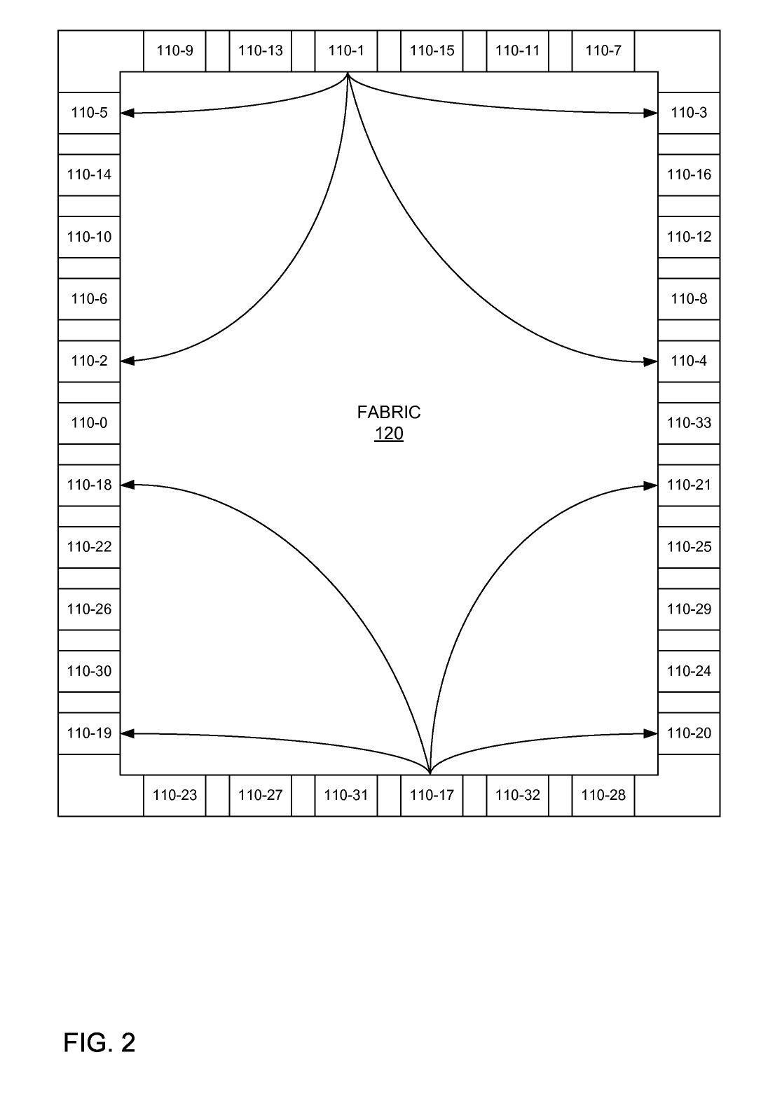

In the present example, assume that the selected distribution tree specifies that the indication of the availability of the packet is to be sent to nodes 110-1 and 110-17, which are the stage one nodes. Node 110-0 may then send an indication of the availability of the packet to those nodes. The indication may include the distribution tree that was selected. Furthermore, the indication may include the fact that the stage zero node is sending the indication. What should be noted is that absent the techniques described herein, node 110-0 would need to send the data packet to all other nodes (e.g. nodes 110-(1-33)). With the techniques described herein, node 110-0 need only send the indication of the availability of the packet to the determined stage one nodes. As such, the amount of bandwidth used by the fabric interface is greatly reduced. The process of receiving the indication of the availability of a data packet at the stage one nodes is described with respect to FIG. 2.

FIG. 2 is an example of stage one of a distribution tree. As mentioned above, nodes 110-1 and 110-17 were selected as the stage one nodes for a given distribution tree. When the indication of the availability of a packet arrives at each of those nodes, the stage determination modules may determine that the indication is coming from a stage zero node, and as such, the nodes are to act as stage one nodes. The indication included the selected distribution tree, and as such, the stage one nodes are able to retrieve the selected distribution tree from the distribution tree module for a stage one node. The selected distribution tree may specify to which nodes the stage one nodes are to forward the indication of the availability of the packet. In other words, the distribution tree identifies the stage two nodes that are to receive the indication of the availability of the packet. In this example, assume that node 110-1 is to forward the indication to nodes 110-2,3,4,5 and that node 110-17 is to forward the indication to nodes 110-18,19,20,21.

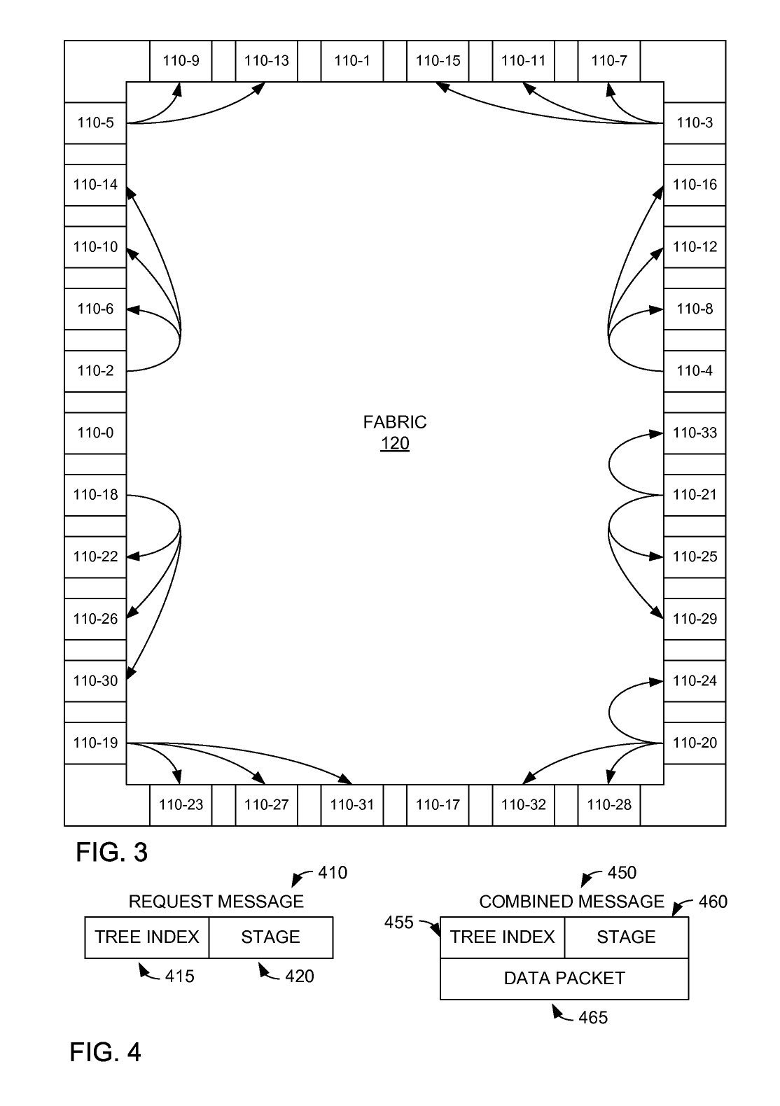

Each of the stage one nodes may then forward the indication of the availability of the data packet to the determined stage two nodes. As shown, each stage one node sends an indication of the availability of the packet to its respective stage two nodes. Just as above, the indication may include the fact that the indication is coming from a stage one node. Again, it should be noted that each of nodes 110-1 and 110-17 is sending the indication of the availability of the packet to a reduced set of overall nodes. In this example, each of the stage one nodes sends the indication to four other nodes, which uses a smaller amount of fabric interface bandwidth than if the stage one nodes were required to send the indication to all other nodes which have not yet received the indication. Processing of the indication of the availability of a packet by a stage two node is described with respect to FIG. 3.

FIG. 3 is an example of stage two of a distribution tree. For each node that receives the indication of the availability of a packet from a stage one node, the stage determination module may determine that the node will act as a stage two node. The indication may then be sent to the stage two module. Using the selected distribution tree, which was included in the indication of the availability of the packet, the stage two module may retrieve the appropriate distribution tree from the distribution tree module. The distribution tree may specify the stage three nodes to which the indication of the availability of the data packet should be sent.

In the present example, assume that node 110-2 has stage three nodes 110-6,10,14, node 110-3 has stage three nodes 110-7,11,15, node 110-4 has stage three nodes 110-8,12,16, node 110-5 has stage three nodes 110-9,13, node 110-18 has stage three nodes 110-22,26,30, node 110-19 has stage three nodes 110-23,27,31, node 110-20 has stage three nodes 110-24,28,32, and node 110-21 has stage three nodes 110-25,29,33. Each of the stage two nodes may then forward the indication of the availability of the packet to their corresponding stage three nodes. The indication may identify that the indication is coming from a stage two node. However, there may be no indication of the selected distribution tree. The reason for this is that in the current example, stage three nodes are the terminal nodes, meaning that the packet does not need to be sent to additional nodes. As such, the stage determination module may determine, based on the fact that the indication is coming from a stage two node, that no further forwarding is needed.

Again, it should be noted that each of the stage two nodes sends the indication of the availability of the packet to a smaller set of nodes, in this example, up to three nodes, than would be required of a stage zero node that simply sends the indication of the availability of the packet to all nodes.

FIGS. 1, 2, and 3 have described how a packet intended for all active nodes may be distributed to those nodes without using a disproportionate amount of fabric interface bandwidth at any given node. The use of fabric interface bandwidth is distributed amongst a larger set of nodes, thus reducing the bandwidth required by any specific node. It should be understood that the example implementation described above is simply an example of one implementation. For example, the above description was based on a device with thirty four possible nodes, however any other number of nodes are possible. Also, the example above described a three stage distribution tree, in which each stage zero node(1) sends the indication to two stage one nodes(2), which in turn send the indication to four stage two nodes(4), which in turn send the indication to up to three stage three nodes(3), forming a 1-2-4-3 distribution pattern. However, it should be understood that other patterns, are also possible. For example, a 1-2-5-5 pattern may accommodate up to sixty three nodes. In addition, although the above description was in terms of a three stage distribution, the techniques described herein would be applicable regardless of the number of stages.

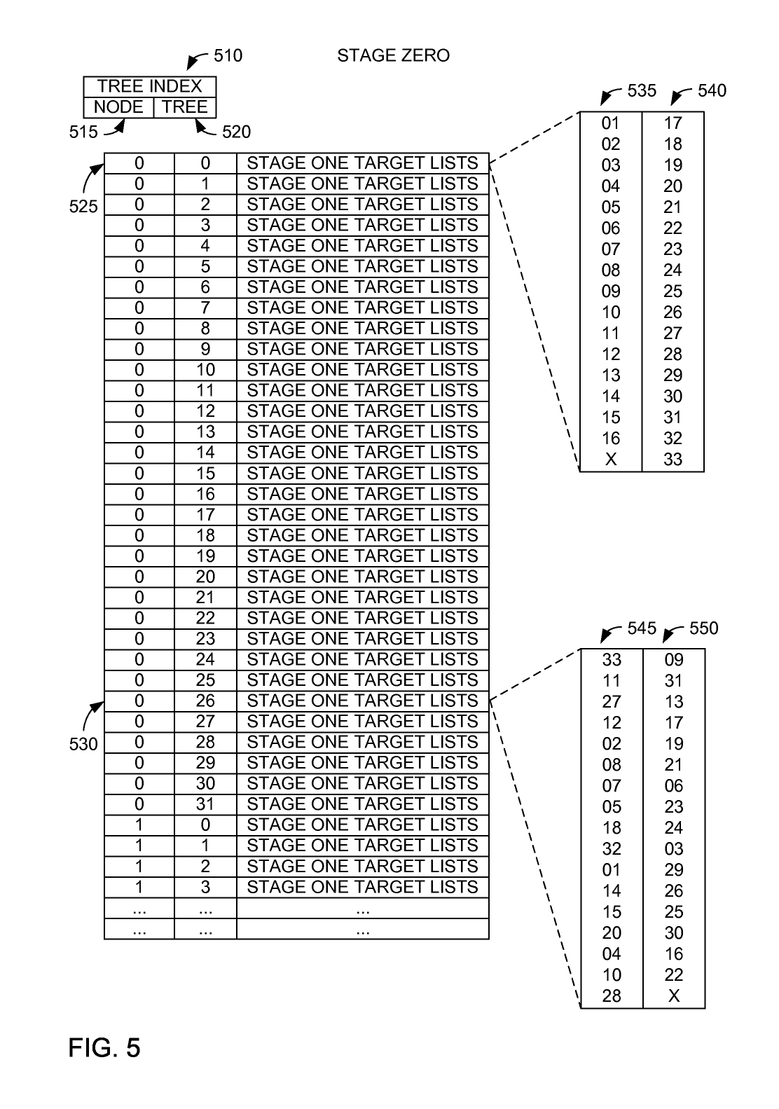

What should be understood is that a packet arriving at an origination node that is destined for multiple nodes may be sent to some first subset of those nodes. The receiving first subset may then forward the packet to a second subset of nodes. The second subset may forward the packets to a third subset. The example presented above stopped at the third subset, but the techniques described herein would be applicable when extended to a fourth or greater subset of nodes. Likewise, a smaller number of stages may also be used. What should be understood is that the pattern may continue until all nodes that need the packet have received the indication of the availability of the packet. The actual nodes that receive the indication of the data packet are determined by the stage number included in the indication which identifies the stage that sent the indication and the selected distribution tree. Distribution trees will be described in greater detail with respect to FIGS. 5-7.

FIG. 4 is an example of packet indication messages. In the networking device described above, there are several different way in which a packet arriving at an origination node may be sent to other nodes. In one example implementation, the packet may arrive at the origination node, but rather than sending the packet immediately to the determined nodes, a request message 410 may be sent instead. The request message may notify the target node that a packet is available. The request message may include the selected distribution tree, which is referred to as the tree index 415. The tree index will be described in further detail below. The request message may also include a stage identifier 420, which identifies the stage which is sending the request message. As explained above, the tree index and the stage are used to determine the subsequent stage nodes to which the request message may be sent. The actual packet may then be sent at a later time. For example, the actual packet may be sent in response to a message from the node that is to receive the packet. In other implementations, the node that sends the request message may autonomously send the data packet at some point in time after sending the request message.

In another example implementation, the networking device may use a combined message 450. The combined message may include the tree index 455 and the stage identifier 460, as described above. The combined message may also include the packet 465 itself. Regardless of implementation, the techniques described to identify subsequent stage nodes are based on the tree index and the stage alone, and are applicable regardless of if the information is included with the packet itself or not. The remainder of this description will be in terms of a request message, however this is for purposes of ease of description. The techniques described herein are applicable regardless of the actual method used to transfer the packet from one node to another.

FIG. 5 is an example of a stage zero distribution table. For purposes of clarity of description a truncated version of the table is shown. The stage zero distribution table may be used by a stage zero node to determine which nodes are the stage one nodes to which a request message should be sent. The stage zero table may include a tree index 510. The tree index may be made up of two fields, a node 515 and a tree 520. The node may refer to the instant node that is accessing the table. For example, if a packet is received at node number three, the node 515 that may be used would be three. The tree 520 specifies a particular distribution pattern. As explained above, there are many different distribution patterns that may be taken by a packet. The tree identifies the particular pattern that is taken. Thus, the combination of a particular node and tree defines the distribution pattern for a packet originating from that node.

As shown in FIG. 5, the nodes start at node zero and would continue through the maximum number of nodes in a given networking device. For purposes of description, FIG. 5 shows thirty two trees for each node. Thus, for a packet arriving at a stage zero node, there are thirty two possible distribution patterns that the packet may follow. However, it should be understood that the description of thirty two possible distribution patterns per node is merely one example of an implementation. The techniques described herein are not limited to any particular number of distribution patterns. It should also be noted that in some implementations, the complete stage zero table is not maintained on each node because the majority of the table will not be used. For example, a given node, such as node one, need only be aware of the stage zero distribution trees for node one. There is no need for node one to maintain the stage zero distribution trees for any other node, other than itself. As such, the table may be reduced to contain only the thirty two (or whatever chosen number) of distribution trees that are applicable for that node.

Given a node, a distribution tree, and thus a tree index, may be selected. For example, a packet may arrive at node zero and tree zero may be selected 525, which defines one distribution tree. Likewise, a packet may arrive at node zero and tree twenty six may be selected 530, resulting in a completely different distribution pattern. Selection of a distribution tree identifies a particular tree index. Once a tree index has been selected, the stage one nodes for that tree may be determined. As shown, each entry in the stage zero table includes two lists of stage one nodes. For example, for tree index 525, the entry contains lists 535, 540, while for tree index 530, the lists are 545,550. For the remainder of this description an X in any list of nodes indicates the end of the list. If the processes described below results in an X being selected, this means that no action is needed.

For purposes of the remainder of this description, assume a packet has arrived at node zero and that tree zero has been selected. The stage zero node may select the first active node in each list, and those nodes may be the stage one nodes. The stage zero nodes may then send the request message to the selected nodes. For purposes of the description of FIGS. 5-7, assume all nodes are active. The case where certain nodes are not active or are not included in a multicast session will be described in further detail with respect to FIG. 8. In this case, the list 535 shows node one as the first node and list 540 shows node seventeen as the first node. As such, nodes one and seventeen may be selected as the stage one nodes. Node zero may then send request messages to nodes one and seventeen. The request messages will include the tree index which identifies the distribution tree as well as the fact that the request message is coming from a stage zero node.

It should be clear that selection of the tree index determines the starting point for the distribution pattern from the stage zero node. For example, had tree index 530 been selected instead of tree index 525, a completely different set of lists of stage one nodes may have been retrieved. As shown, the first entry in each of lists 545, 550 are nodes thirty three and nine, respectively. Thus, if tree index 530 were selected, different stage one nodes may have been selected. The actual distribution pattern may then depend on the selected tree and the determination of which nodes actually need the packet.

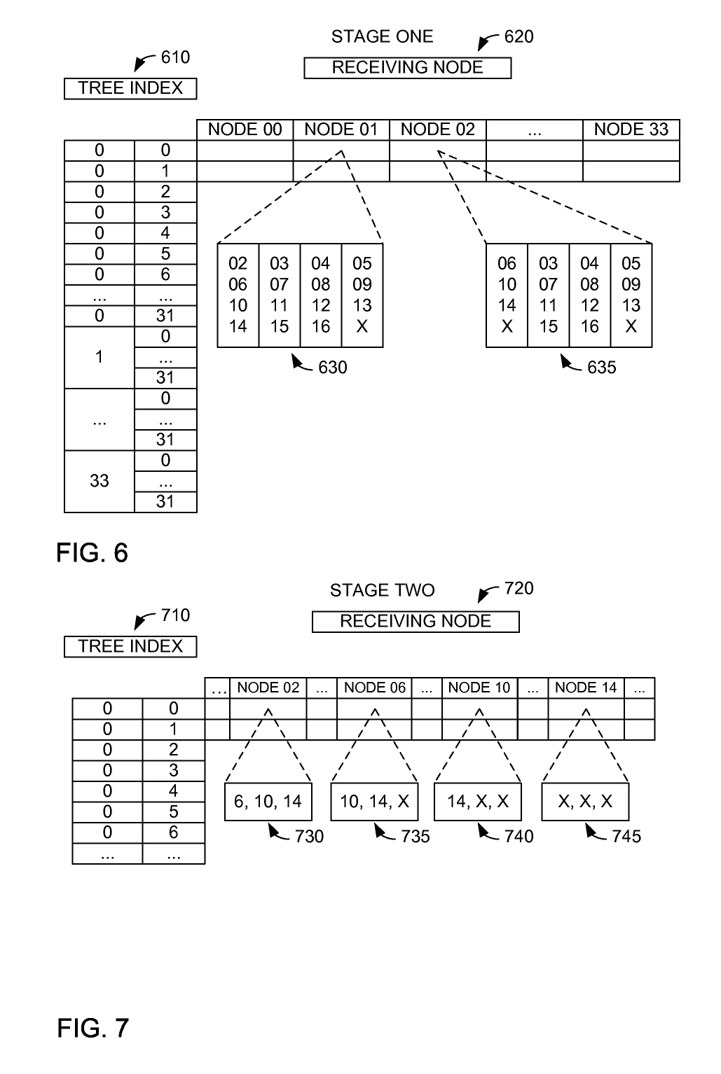

FIG. 6 is an example of a stage one distribution table. For purposes of clarity of description a truncated version of the table is shown. Just as with the stage zero distribution table, the stage one distribution table contains a tree index 610. As described above, the request message includes the stage number of the source of the request message. Thus, a request message received from a stage zero node indicates that the receiving node is a stage one node and as such should access the stage one distribution table. The request message also includes the selected tree index, so a stage one node is able to determine the proper row to select from the stage one distribution table. The stage one distribution table also includes a receiving node 620, which indicates all the possible receiving nodes. Just as above, in some implementations, the stage one table may only include the column of the node that is receiving the request message from a stage zero node. For example, the stage one table for node one may only include the column labeled node one, because node one does not need the stage one distribution table for any other nodes. Again, the techniques described herein are applicable, even if only a subset of the complete stage one table is present on any given node.

A node receiving a request message may first determine that it is a stage one node by examining the request message, which includes the stage of the node that sent the message. Thus, if a request is received from a stage zero node, the receiving node is a stage one node. Also included in the request message is the selected tree index. Based on these two pieces of information, the stage one node, which knows its own node number, is able to select the proper entry in the stage one distribution table. Each entry in the stage one table comprises four lists of stage two nodes. The stage one node may select the first active node in each list and send a request message to each of those nodes.

Continuing with the example presented above, node one may receive a request message from node zero. As such, entry 630 is selected. Assuming all nodes are active, node one may send a request message to the first node in each list. In other words, node one may send a request message to nodes two, three, four, and five. The request messages include the fact that the message is coming from a stage one node and that the selected tree index is node zero, tree zero.

Although the situation when not all nodes are active is described in detail below, it is worth noting at this point that a stage one distribution entry exists for all nodes. For example, assuming that nodes one and seventeen were selected as the stage one nodes, and based on the tree index, it would appear that node two would not receive a request message from a stage zero node with the selected tree index. However, this may occur in cases where a node is not active. For now, it should be observed that the node two stage one table entry for tree index with node zero, tree zero is also populated with four lists. It should be further noted that the lists are not independent of each other. For example, the entry for node two 635 contains four lists. The first of these lists includes nodes six, ten, and fourteen, which are the same as the last three entries in the first list of entry 630. As will be explained in detail below, this ensures that all nodes that are to receive a request message will still receive it, even when some of the nodes are not active.

FIG. 7 is an example of a stage two distribution table. For purposes of clarity of description a truncated version of the table is shown. Just as with the stage one distribution table described above, the stage two distribution table contains a tree index 710. The stage two distribution table also includes a receiving node 720. Just as above, a request message may include the stage number of the sender of the request message as well as the selected tree index. Based on these two pieces of information, the correct entry within the stage two distribution table may be selected. Again, just as above, the stage two distribution table may be reduced in size by only including the receiving node column that is appropriate for a given node (e.g. node number two would only need the column labeled node two).

A node receiving a request message may first determine that it is a stage two node by examining the request message, which includes the stage of the node that sent the message. Thus, if a request is received from a stage one node, the receiving node is a stage two node. Also included in the request message is the selected tree index. Based on these two pieces of information, the stage two node, which knows its own node number, is able to select the proper entry in the stage two distribution table. Each entry in the stage two distribution table comprises one list of stage three nodes. The stage two node may send a request message to each active node in the list of stage three nodes.

Continuing with the example presented above, node two may receive a request message from node one. As such, entry 730 is selected. Assuming all nodes are active, node two may send a request message to all the active nodes in entry 730. In other words, node two may send a request message to nodes six, ten, and fourteen. The request messages include the fact that the message is coming from a stage two node and that the selected tree index is node zero, tree zero.

It is again worth noting that it has been assumed that all nodes are active. This may not always be the case. Continuing with the example above, if node one was selected as the stage one node, the first list of entry 630 indicates node two should be selected, if active. However, if node two is not active, the next entry, node six, on the list would be selected. Thus, it is possible that node six would receive the request message from node one. For now, it should be observed that the node six stage two table entry for tree index with node zero, tree zero is also populated with a list of stage three nodes. Again, it should be further noted that the lists are not independent of each other. For example, the entry for node six 735 contains one list that includes nodes ten and fourteen, which is a subset of the node two entry 730. Likewise, the node ten entry 740 includes one list that includes node fourteen, which is a subset of both the node two entry 730 and the node ten entry 735. The node fourteen entry 745 includes no nodes. As will be explained in detail below, this ensures that all nodes that are to receive a request message will still receive it, even when some of the nodes are not active.

FIG. 8 is an example of pruning a distribution tree. As was mentioned above, the preceding description generally assumed that the networking device was fully populated with the maximum number of allowed nodes and that all of those nodes were active. Although these assumptions were useful for purposes of basic description, the assumptions may not necessarily hold true in an operational setting. For example, a networking device may be capable of being equipped with thirty four nodes but based on expected traffic, not all nodes may need to be populated. In addition, even if a certain number of nodes have been equipped, it is possible that some of those nodes may not be operational at any given time. For example, a line card containing a node chip may have been removed from the networking device for maintenance reasons.

To illustrate why nodes that are inactive may cause a problem, consider the following example, which generally follows the examples presented above. Once again, assume that a packet has arrived at node 110-0. Based on the description above, node 110-0 will be the stage zero node. Assuming the same distribution tree as above was selected, node 110-0 would, absent the techniques now being presented, select nodes 110-1 and node 110-17 as the stage one nodes. A request message may then be sent to those two nodes. However, assume that node 110-1 is not active. If node 110-1 is not active, it cannot receive the request message from node 110-0. Furthermore, node 110-1 would not be able to send the request message on to the selected stage two nodes 110-2,3,4,5. In turn, these four nodes would not receive the request message, and thus could not send the request message to the stage three nodes. Thus, a large number of nodes, which may be active, will not receive the request message, due to a single node being inactive. Overcoming this problem may require that the distribution tree be “pruned” to exclude nodes that are not active. The pruning must be done in such a way that all active nodes still receive the request message.

In addition to pruning the distribution tree for nodes that are not active, it may also be useful to prune the tree for nodes that do not need the packet. For example, as mentioned above, in the case of multicast packets, the packet may not be needed by every node. Thus, it may be more efficient to only include the nodes in the distribution tree that actually need the packet. Continuing with the example above, if node 110-1 was active, but did not need the packet (e.g. no port associated with node 110-1 is part of the multicast session), sending the packet to node 110-1 would be wasteful. Rather, the node could simply be bypassed, just as if it were not active, resulting in a more efficient distribution of the packet to only nodes that need it.

The techniques described herein overcome this problem through the use of priority ordered lists within each of the stage distribution tables. As briefly mentioned above, for the stage zero and stage one tables, each entry contains a plurality of lists of nodes. When selecting a node from each list, the node will select the first active node within each list. For example, each node may maintain an active nodes table. This table may list all nodes within the networking device that are currently active. Prior to selecting a node from one of the lists, the node may access the active nodes table to determine if the node is active. If so, the node may be selected. If not, the next node on the list may be compared to the active node table. This process may continue until an active node is found. If no active node is found, then there is no subsequent stage node to which the request message should be sent. In the case of multicast packets, it may further be determined if the node is actually included in the multicast session, and thus needs the packet. If not, the node may be treated just as if it were not active, and the next node in the list examined.

The process of pruning the tree described above may be easier to describe through the use of an example. In general, the example presented will follow the example used with respect to FIGS. 1-3. In particular, a packet may be received by node 110-0, and this packet may be destined for all active nodes. Just as above, assume the selected tree index is node zero, tree zero, which is the same distribution tree that was selected in the example presented with respect to FIGS. 1-3. For purposes of this example, assume that node 110-1 is not active. Furthermore, although the example is presented in terms of a node that is not active, the same process may occur if the nodes is active, but the packet is a multicast packet, and the node is not included in the multicast session.

Just as above, node 110-0 may access the stage zero table that is depicted in FIG. 5. The list 535 starts with node one, then two, and so on. The first node, node one, may be compared to the active nodes table. Based on the previous assumptions, node one is not active. As such, the next node in list 535, which in this example is node two, may be retrieved. It may again be determined if the node is active. For purposes of this description, assume that node two is active. When sending the request message on to the stage one nodes, node two is selected. As shown in FIG. 8, node 110-0 sends the request message to node 110-2. For purposes of clarity of description, the request message to node seventeen, which is assumed to be active and is the first node in list 540, has been omitted. However, it should be understood that the request message sent to node seventeen, which cascades to the stage two and three nodes still occurs, just as was described with respect to FIGS. 1-3.

Node 110-2 may then receive the request message from node 110-1. Just as above, the request message indicates which tree index has been selected and that the request message is coming from a stage zero node. As such, node 110-2 may then access the stage one table shown in FIG. 6. Node 110-2 may then access entry 635 as indicated by the fact that the request message came from a stage zero node, and that the receiving node is node two. Again, the four lists are retrieved from this entry. Node two may then send the request message on to the first active node in each list.

Assuming all nodes other than node one are active, node two will send the request message to nodes six, three, four and five, with an indication that the request is coming from a stage one node. For purposes of clarity, FIG. 8 omits the request message sent to nodes three, four, and five. However, it should be understood that the process proceeds with respect to those nodes just as if the request message had come from node one. As shown in FIG. 8, a request message may be sent from node two to node six, which is the first active node in the first list 635.

The request message from node two may then be received by node six. Node six determines that it is acting as a stage two node, because the request message came from a stage one node. Using the included tree index, node six may retrieve list 735. Included in the list are nodes ten and fourteen. Thus, node six may determine which of those nodes are active. However, in the case of a stage three node, the request message is sent to all active nodes within the list, not just the first one. As shown in FIG. 8, node 110-6 sends request messages to nodes ten and fourteen. Thus, all of the active nodes (absent the assumed inactive node one) receive the request message just as occurred with respect to the example in FIGS. 1-3, despite the fact that node one was not active.

The techniques of pruning the distribution tree described above works regardless of the number of nodes that are not active. For example, assume that both nodes one and six were not active. The first list in entry 635 has the priority ordered list of node six, ten, and fourteen. If node six was not active, then the next node, node ten, would be selected. When node ten receives the request message from a stage one node, the entry 740 which is retrieved indicates that the request should be sent to node fourteen. Likewise, if nodes one, six, and ten were not active, the first list of entry 635 would indicate that the request message should be sent to node fourteen. The node fourteen entry 745 in the stage two table indicates that the request message need not be sent again.

What should be clear from the above description is that the process of pruning the tree results in all active nodes receiving the request message. Any given node simply determines which stage it is acting as and what the selected tree index is. From there, the appropriate entry in the appropriate stage distribution table is selected. Then, it is simply a matter of selecting either the first active node in each list (in the case of stage zero or one) or selecting all active nodes in the list (in the case of stage two) and sending the request on to those nodes. Any individual node need not be aware that any pruning of the tree has occurred. Rather, if the steps outlined above are followed it can be ensured that all active nodes will receive the request message.

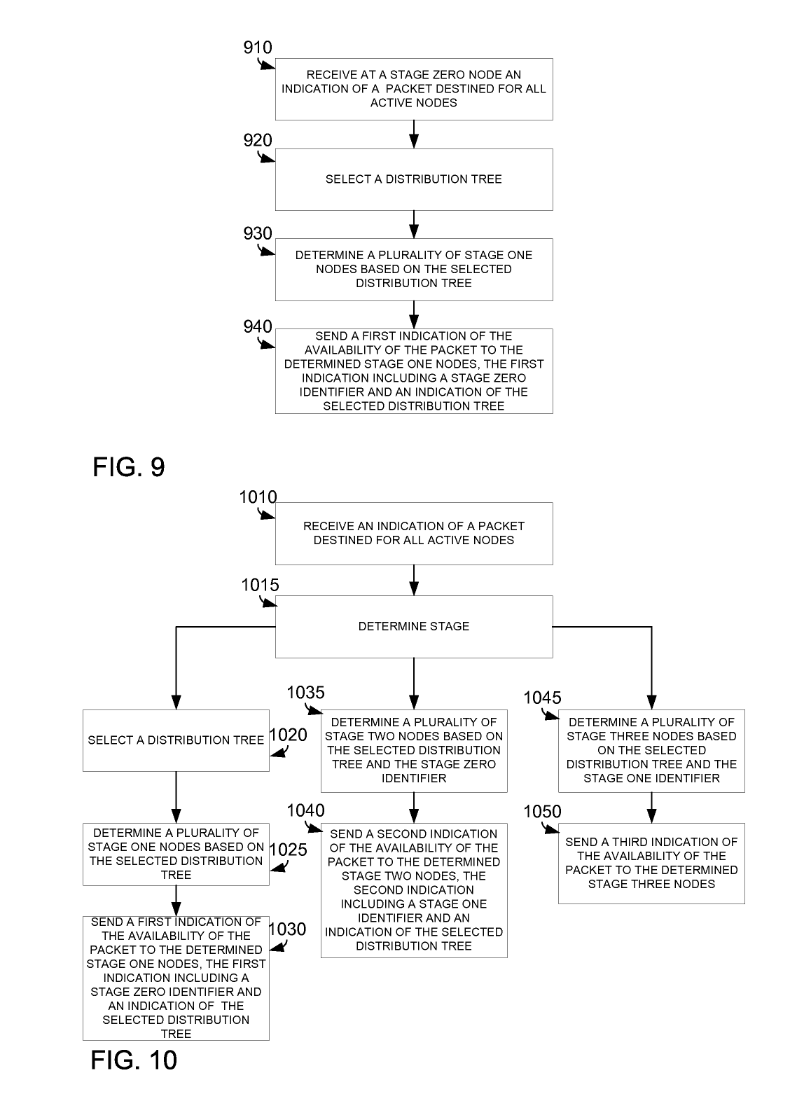

FIG. 9 is an example of a high level flow diagram for distributing a packet. In block 910 an indication of a packet destined for all active nodes may be received at a stage zero node. For example, this may be a multicast packet that is received from an external port. In block 920, a distribution tree may be selected. The distribution tree determines the path that the packet will take through the networking device. In block 930 a plurality of stage one nodes may be selected based on the selected distribution tree. For example, the lists associated with the stage zero table may be retrieved, and the first active node within each list may be selected. In block 940, a first indication of the availability of the packet may be sent to the determined stage one nodes. The indication may include a stage zero identifier and an indication of the selected distribution tree.

FIG. 10 is another example of a high level flow diagram for distributing a data packet. In block 1010 an indication of a packet destined for all active nodes may be received. In block 1015 the stage may be determined. If the stage is zero, meaning the packet is being received from an external port at an originating node, the process moves to block 1020. In block 1020 a distribution tree may be selected. In block 1025 a plurality of stage one nodes may be determined based on the selected distribution tree. In block 1030 a first indication of the availability of the packet may be sent to the determined stage one nodes. The first indication may include a stage zero identifier and an indication of the selected distribution tree.

If it is determined in block 1015 that the stage is stage one, the process moves to block 1035. In block 1035 a plurality of stage two nodes may be determined based on the selected distribution tree and the stage zero identifier. In block 1040 a second indication of the availability of the packet may be sent to the determined stage two nodes. The second indication may include a stage one identifier and an indication of the selected distribution tree.

If it is determined in block 1015 that the stage is stage two, the process moves to block 1045. In block 1045 a plurality of stage three nodes may be determined based on the selected distribution tree and the stage one identifier. In block 1050 a third indication of the availability of the packet may be sent to the determined stage three nodes.

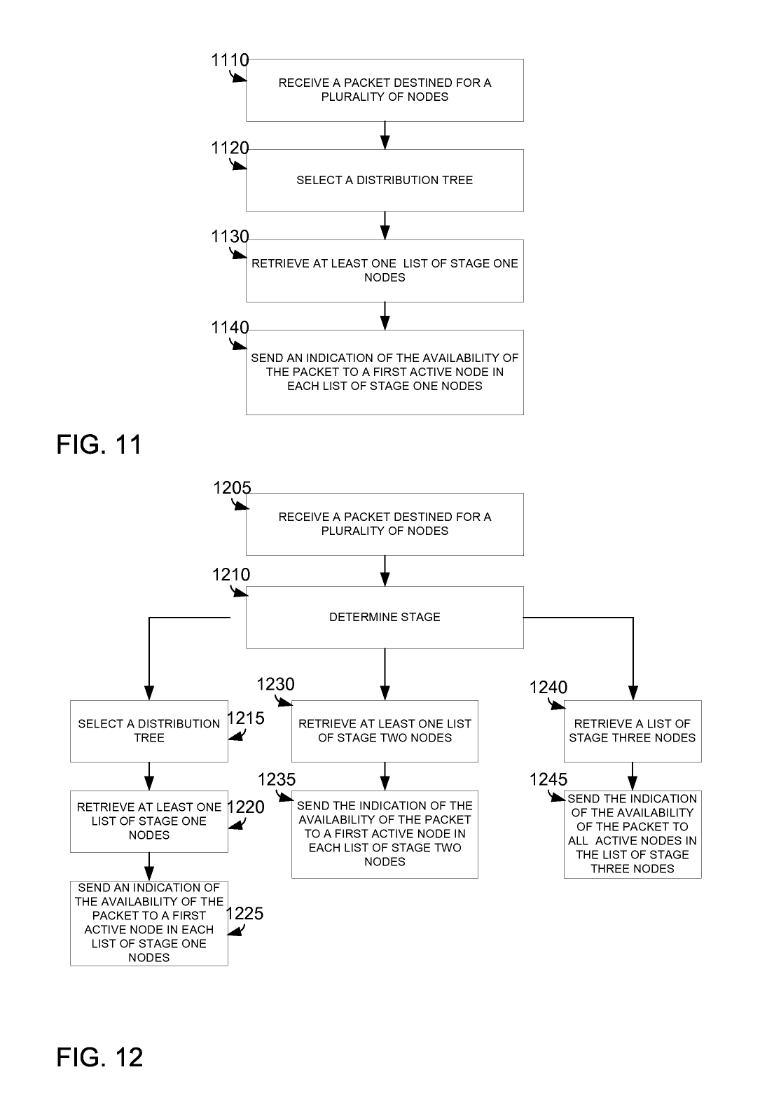

FIG. 11 is an example of a high level flow diagram for distributing a packet with distribution tree pruning. In block 1110 a packet destined for a plurality of nodes may be received. For example, the packet may be received from an external port. In block 1120 a distribution tree may be selected. In block 1130 at least one list of stage one nodes may be retrieved. For example, in the implementation described above, two lists of stage one nodes may be retrieved. In block 1140 an indication of the availability of the packet may be sent to a first active node in each list of stage one nodes. For example, a request message may be sent to the first active node in each of the two lists of stage one nodes. By selecting the first active node, the distribution tree may be pruned of nodes that are not active and as such cannot participate in the distribution of the packet.

FIG. 12 is another example of a high level flow diagram for distributing a packet with distribution tree pruning. In block 1205 a packet destined for a plurality of nodes may be received. In block 1210 it may be determined which stage has received the packet. If the packet is received by a stage zero node, the process moves to block 1215. In block 1215 a distribution tree may be selected. In block 1220 at least one list of stage one nodes may be retrieved. In block 1225 an indication of the availability of the packet may be sent to a first active node in each list of stage one nodes.

If it is determined in block 1210 that the packet is received by a stage one node, the process moves to block 1230. In block 1230 at least one list of stage two nodes may be retrieved. In block 1235 an indication of the availability of the packet may be sent to a first active node in each list of stage two nodes. If it is determined in block 1210 that the packet is received by a stage two node, the process moves to block 1240. In block 1240 a list of stage three nodes may be retrieved. In block 1245 the indication of the availability of the packet may be sent to all active nodes in the list of stage three nodes.

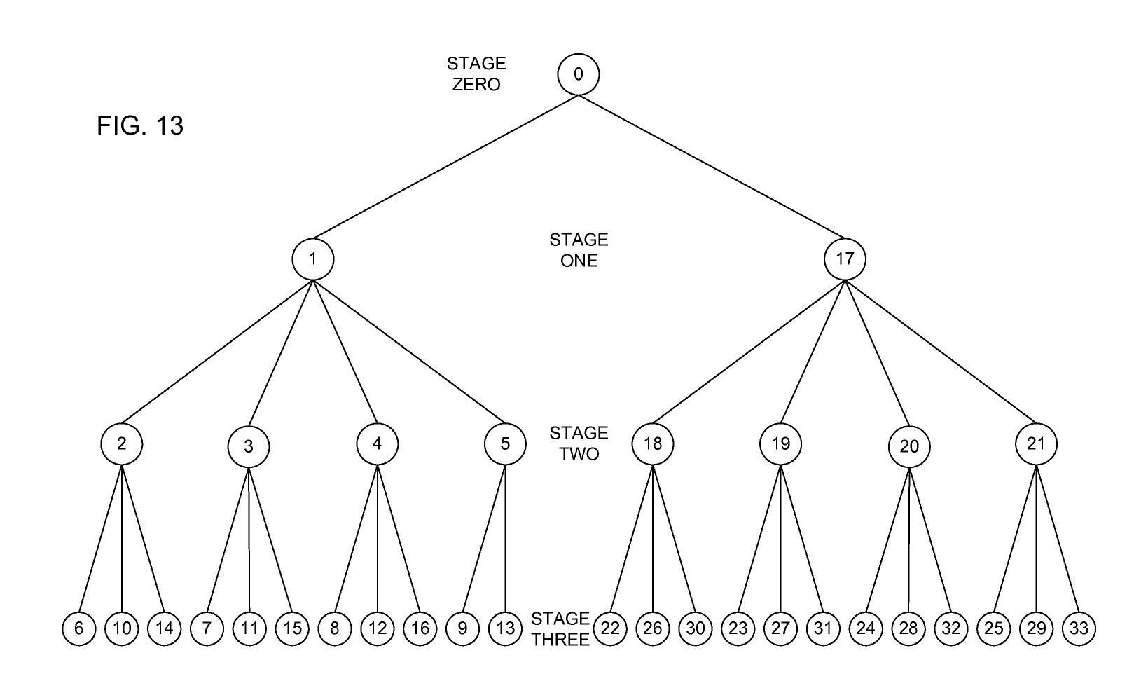

FIG. 13 depicts an example of populating the distribution tree tables. In the preceding description, it has been assumed that the distribution tree tables have been populated such that all nodes simply perform the proper table lookups and are able to determine the correct nodes to which to send request messages. FIG. 13 describes one method for populating the tables. The process may start by creating an empty distribution tree. In the example described above, a single stage zero node sends the request to two stage one nodes, which in turn send the request to four stage two nodes, which in turn send the requests to up to three stage three nodes. As shown, the circles represent the nodes at the various stages. The next step is to then to populate the stage zero node with an actual node number. As shown, in this case, the stage zero node has been set to node zero. At this point, the remaining circles may be filled using the remaining node numbers. For example, in the case of a networking device with thirty four nodes, after populating the stage zero node with node zero, nodes one through thirty three remain to be assigned.

At this point, the remaining nodes may be distributed to all of the remaining circles in any fashion. They may be distributed at random, or may be manually placed. Once all of the remaining nodes have been placed, this completes a single distribution tree. If the node numbers are redistributed, then this creates a new distribution tree. As should be clear, there are a very large number of possible distribution trees. The examples described above were limited to thirty two trees for purposes of clarity of explanation. There is no limitation on the number of possible distribution trees, other than the maximum number of different combinations that are possible.

In order to populate the two stage one lists, the first entry in each list may be populated with the node numbers contained in each of the stage one circles. As shown, nodes one and seventeen occupy those positions. For the remainder of this description, the focus will be on the portion of the tree formed from node 1 and below, however it should be understood that the same process may occur with the other half of the distribution tree. The remainder of the stage one list that begins with node one may then be populated with all of the nodes below node one. The list may be populated by moving from left to right, and top to bottom within the portion of the tree. For example, at stage two, moving from left to right, the node numbers are two, three, four, and five. Moving down and starting from the left, the node numbers are six, ten and so on. As such, one of the stage one lists could be populated in this manner. Thus, when selecting a stage one node, the process described above will first check if node one is active. If not, it tries to find a node within stage two that is active. If none is found there, it tries to find a stage three node that is active.

The process with respect to the stage one distribution tree is similar. First, a stage one node is selected. For example, node number one may be selected. If all nodes are active, then node one would send request messages to nodes two, three, four, and five. Thus those nodes would each be placed in the first position of each of the four stage one lists associated with node one for this particular distribution tree. The remaining slots for each list could then be the stage three nodes, proceeding from left to right, that are beneath the node. In the case of node two, nodes six, ten, and fourteen are the nodes under node two. Thus, the stage two list beginning with node two would also contain, in order, nodes six, ten, and fourteen. The same process occurs for all of the other stage two nodes.

As should be clear, following the process above allows the stage tables to be populated such that request messages will be sent to all nodes, assuming all nodes are active. However, there is the possibility that any given node may be inactive. This description may be better understood in conjunction with entry 635 in FIG. 6. Following the example described above, assume that node one is not active. According to the population process described above, node two then becomes the first active node in the first stage zero list. Node two is thus now responsible for sending all request messages that would have been sent by node one. As such, node two now acts as the stage one distribution node for this particular distribution tree. In other words, node two is essentially slid upwards into the position previously occupied by node one. Node two is now responsible for sending the request message to nodes three, four, and five. In addition, node two was previously responsible for sending the request message to nodes six, ten, and fourteen when acting as a stage two node. However, node two is now acting as a stage one node. As such, node two sends the request message to the first active node, in order, of nodes six, ten, and fourteen. The same process may be followed for all other nodes.

Assuming that node two is now acting as the stage one node, the request message may be received by the first active node of the list of nodes six, ten, and fourteen. The following description may be better understood in conjunction with entries 730-745 in FIG. 7. As shown in entry 730, when node two acts as the stage two node, it sends request messages to nodes six, ten, and fourteen. However, now that node two is acting as a stage one node, the request message is received as if coming from a stage one node. Assuming that node six is active, node two would then be responsible for sending a request message to node six. Node six would then be responsible for sending the request message to the remaining stage three nodes, node ten and fourteen. This is reflected in entry 735. However, assuming node six is not active, the next node would be node ten. Thus, if node ten is active, the request message is sent to that node, which is then responsible for sending the request message to the remaining stage three nodes, which in this case is node fourteen. As shown in entry 740, node ten would send the request message to node fourteen. Finally, if node fourteen is the only active node, there are no other active stage three nodes. Thus, node fourteen, as indicated by entry 745, does not need to send the request message to any additional nodes.

It should be noted that the distribution trees and the nodes included in each list are not necessarily static. The distribution trees may be defined at the time the system is designed. Thus, once the distribution trees are created, they need not be altered. However, once the networking device is operational, the distribution trees may be dynamically changed based on current operating conditions. For example, if a node is taken out of service, or is not equipped, the distribution trees may be repopulated. In one example, implementation, the process described above may occur again whenever there is a change in the operational status of the networking device, and the distribution trees populated based on only the nodes that are active. The determination of the actual node value present in each of the lists in the distribution tables may be a manual, automated, or some combination thereof, process. The lists may be static, dynamic, or a combination thereof.

I claim:

1. A method comprising:
receiving, at a stage zero node, a packet destined for all active nodes;
selecting a distribution tree;
determining a plurality of stage one nodes based on the selected distribution tree; and
sending a first indication of the availability of the packet to the determined stage one nodes, the first indication including a stage zero identifier and an indication of the selected distribution tree.

2. The method of claim 1 further comprising:
receiving, at the stage one nodes, the first indication of the availability of the packet;
determining a plurality of stage two nodes based on the selected distribution tree and the stage zero identifier; and
sending a second indication of the availability of the packet to the determined stage two nodes, the indication including a stage one identifier and an indication of the selected distribution tree.

3. The method of claim 2 further comprising:
receiving, at the stage two nodes, the second indication of the availability of the packet;
determining a plurality of stage three nodes based on the selected distribution tree and the stage one identifier; and
sending a third indication of the availability of the packet to the determined stage three nodes.

4. The method of claim 3 wherein the first, second, and third indications of the availability of the packet are sent with the packet.

5. The method of claim 3 wherein the first, second, and third indications of the availability of the packet are sent separately from the packet.

6. A device comprising:
a plurality of nodes, each node comprising:
a distribution tree module to store a plurality of distribution trees;
a port interface module to receive a packet from a port and forward an indication of the availability of the packet to a stage determination module;
the stage determination module to determine the stage of the packet based on the indication and forward the indication to one of a plurality of stage modules;
the plurality of stage modules to receive the indication and determine a reflection node based upon the distribution tree stored in the distribution tree module and forward the indication to a fabric interface module; and
the fabric interface module to send the indication to the determined reflection node.

7. The device of claim 6 wherein the plurality of stage modules includes:
a stage zero module to select a distribution tree from the plurality of stored distribution trees.

8. The device of claim 7 wherein the stage zero module is a module to:
retrieve a plurality of stage one target lists from the selected distribution tree and to reflect the indication to the first active node in each stage one target list.

9. The device of claim 8 wherein the plurality of stage modules includes:
a stage one module to retrieve a plurality of stage two target lists from the selected distribution tree and to reflect the indication to the first active node in each stage two target list.

10. The device of claim 9 wherein the plurality of stage modules includes:
a stage two module to retrieve a stage three target list from the selected distribution tree and to reflect the indication to all active nodes in the stage three target list.

11. A method comprising:
receiving a packet destined for a plurality of nodes;
selecting a distribution tree;
retrieving at least one list of stage one nodes; and
sending an indication of the availability of the packet to a first active node in each list of stage one nodes.

12. The method of claim 11 further comprising:
receiving the indication of the availability of the packet at a stage one node;
retrieving at least one list of stage two nodes; and
sending the indication of the availability of the packet to a first active node in each list of stage two nodes.

13. The method of claim 12 further comprising:
receiving the indication of the availability of the packet at a stage two node;
retrieving a list of stage three nodes; and
sending the indication of the availability of the packet to all active nodes in the list of stage three nodes.

14. The method of claim 13 wherein the packet is received from an external port and the indication of the availability of the packet is sent to the stage one, two, and three nodes over a fabric.

15. The method of claim 14 wherein the lists of stage one, two, and three nodes are indexed by a distribution tree index, a stage that is receiving the indication of the availability of the packet, and a node number of the receiving node.
